(19) United States
(12) Patent Application Publication
(10) Pub. No.: US 2006/0035197 A1
(43) Pub. Date: Feb. 16, 2006

(54) Molded article for dental use

(76) Inventor: Munemitsu Hishimoto, Kyoto (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/539,905

(22) PCT Filed: Dec. 18, 2002
(86) PCT No.: PCT/JP02/13213

§ 371 Date: Jun. 16, 2005

(51) Int. Cl. A61C 13/08

(52) U.S. Cl. 433/212.1

(57) ABSTRACT

It is intended to provide a molded article for dental use which is highly safe and free from the elution of bisphenol A with a fear of causing endocrine disruption and can fulfill the properties required in temporary crowns, denture bases, artificial teeth, orthodontic devices, etc. Namely, a molded article for dental use having a definite shape to be used in the oral cavity which is made of a copolymer polyester resin comprising a polyethylene terephthalate (PET) constitutional unit and a poly-1,4-dimethylene cyclohexane terephthalate (PCT) constitutional unit. Different from commonly employed PET, the above resin has been made amorphous by 1,4-cyclohexane dimethanol (CHDM) and therefore has a characteristic that a highly transparent molded article having excellent mechanical properties can be obtained therefrom by various molding methods (injection molding, compression molding and vacuum molding).

### TECHNICAL FIELD

The present invention relates to a molded article for dental use with which there is no fear of elution of bisphenol A, which is very safe, and which can also provide a variety of properties which are required for temporary crowns, denture bases, artificial teeth and the like.

### BACKGROUND OF THE INVENTION

Until now, polycarbonate has been utilized as a material for denture bases and a material for manufacturing temporary crowns and the like in the field of dentistry. Polycarbonate is a plastic having thermo plasticity with aromatic polycarbonate bonds, and has excellent properties for practical use (physical properties, resistance to heat, resistance to cold and the like).

In recent years, however, the endocrine disrupting effects of bisphenol A and the like have been pointed out as an environmental hormone issue, and polycarbonate that has been widely used in the dental field has become considered as a problem because i) polycarbonate is synthesized from bisphenol A as a starting material, and ii) polycarbonate produces bisphenol A as a result of hydrolysis, and therefore, a material that can substitute polycarbonate and which does not produce bisphenol A has been desired.

The following requirements, for example, can be cited for temporary crowns.

1) It is necessary to put a semi-opaque yellow in a molded product, and therefore, the material itself must have a transparent tone.

2) The material must have toughness and resistance to impact shock so that there is no risk of cracking at the time when a thin mold is trimmed with scissors or the like.

3) The material must be resistant to solvent, so that surface coarseness or destruction is not caused when making contact with an ester based solvent (MMA).

4) The material must be adhesive to MMA-PMMA based resins.

5) The material must be able to be utilized as medical apparatuses and must be safe, so that it can be authorized by Food Sanitation Law, the FDA or the like.

6) The material must be easy to cut, and polish, and must have excellent resistance to wear.

Until now, however, no material that can substitute polycarbonate while meeting the performance demands of temporary crowns has been found, nor have materials for denture bases and artificial teeth.

An object of the present invention is to provide a molded article for dental use which solves the above described problems, which does not elute bisphenol A that has the probability of causing endocrine disrupting effects, which is very safe, and which sufficiently satisfies a variety of properties that are required for temporary crowns, denture bases, artificial teeth and the like.

The present inventors have conducted meticulous examination of a variety of substitute materials that do not have any problems of endocrine disrupting effects, and as a result, have confirmed that glycol degenerative PET (a copolymer polyester resin of polyethylene terephthalate (PET) and poly-1,4-dimethylene cyclohexane terephthalate (PCT)), which has become widely used for building materials, films and the like as substitutes for vinyl chloride in the general industrial field, and which is currently utilized for housings, connectors and the like of dialyzers in the medical field, sufficiently satisfies a variety of properties (safety, adhesiveness, resistance to shock impact, resistance to wear and the like) required for molded articles for dental use such as temporary crowns, and thus, causes no problems in practical use, and in this manner, the present invention was completed.

### DISCLOSURE OF THE INVENTION

A molded article for dental use according to the present invention that can solve the above described problems is a mold having a predetermined form so as to be suitable for use within an oral cavity, and is characterized in that this mold is formed of a copolymer polyester resin made up of polyethylene terephthalate constitutional units and poly-1,4-dimethylene cyclohexane terephthalate constitutional units.

Furthermore, the molded article for dental use that is characterized as described above according to the present invention is characterized in that the above described molded article for dental use has a form selected from a group consisting of a temporary crown, a denture base, an artificial tooth and an orthodontic device.

### BEST MODE FOR CARRYING OUT THE INVENTION

In the following, a molded article for dental use according to the present invention is described.

A molded article for dental use according to the present invention is gained by forming a copolymer polyester resin made up of polyethylene terephthalate (PET) constitutional units and pol1,4-dimethylene cyclohexane terephthalate (PCT) constitutional units, and this resin is a copolymer of terephthalic acid, ethylene glycol and 1,4-cyclohexane dimethanol (CHDM) . This copolymer polyester resin (copolyester) is different from a general PET that has been known until now, and the quality has been altered so as to be amorphous using CHDM, and therefore, the copolymer polyester resin has properties where high transparency and physical performance can be gained according to a variety of molding methods.

The copolymer polyester resin that forms a molded article for dental use according to the present invention may include more PET component than PCT component, or may include more PCT component than PET component, and a product that is commercialized in pellet form or the like, for example, Eastar™ or Codar™ by Eastman Chemical Company, can be utilized for such a resin, and any of an injection molding method, a compression molding method and a vacuum molding method may be utilized at the time when a temporary crown is formed using such a resin. Meanwhile, an injection molding method or a compression molding method is appropriate at the time when a denture base or an artificial tooth is formed. A copolymer polyester resin having the above described composition is easy to mold, and therefore, the molding conditions for the respective molding methods may be general conditions, and the copolymer polyester resin can be easily processed using a general purpose molding machine.

In the case where a molded article for dental use according to the present invention is manufactured in accordance with an injection molding method, first, a material in pellet form is dried following instruction by the maker, and after that, the temperature of the barrel of a general purpose injection molding machine is set at a temperature between 200° C. and 280° C., so as to soften and melt the material, after which injection molding is carried out. Though a good molded article can be gained under any condition in the above described temperature range, a barrel temperature of 220° C. to 240° C. is particularly preferable for Eastar 6763 (that includes more PET component than PCT component) made by Eastman Chemical Company, for example, and a barrel temperature of 250° C. to 270° C. is particularly preferable for Eastar DN004 (that includes more PCT component than PET component) made by Eastman Chemical Company.

In addition, in the case where a compression molding method is used, a material in pellet form or a molded article in sheet form is dried following instructions by the maker, if necessary, and after that, softened and melted in a general purpose infrared ray electric furnace, in a range from 130° C. to 280° C., and subsequently, compression molding is carried out using a general purpose compression molding machine. Though a good molded article can be gained under any condition in the above described temperature range, a softening and melting temperature between 150° C. and 200° C. is particularly preferable for Eastar 6763 made by Eastman Chemical Company, for example, and a softening and melting temperature between 170° C. and 220° C. is particularly preferable for Eastar DN004 made by Eastman Chemical Company.

In the case of a molded article for dental use according to the present invention that has been gained by forming a copolymer polyester resin made up of PET constitutional units and PCT constitutional units, the molded article for dental use is not synthesized from bisphenol A as a starting material, and therefore, there is no problem of elution or production of bisphenol A at the time of use, and it can be safely utilized as a medical device, as it is safe enough to be authorized by Food Sanitation Law, the FDA and the like. In addition to this, this molded article for dental use satisfies all of the above described variety of requirements for a temporary crown, and the material itself has a color tone of transparent, making it possible to apply a semi-opaque yellow to the mold, the material has excellent resistance to impact shock, and thus, no cracking is caused at the time of trimming of the mold, and the mold is easy to cut and polish, and has excellent resistance to wear. In addition, the material has excellent resistance to solvent, no coarseness or destruction is caused when contact is made with an ester based solvent (MMA), and the mold has adhesiveness to an MMA-PMMA based resin.

As described above, a copolymer polyester resin that forms a molded article for dental use according to the present invention is very useful for a polycarbonate substituting material in the dental field, and in particular, appropriate for temporary crowns, denture bases, artificial teeth, orthodontic devices (in particular, plastic mold parts of orthodontic apparatuses) and the like.

Here, according to the present invention, it is also possible to mix in organic filler, glass fibers or the like, in the case where it is necessary to enhance the physical properties of the molded article for dental use.

In the following, examples of the present invention are described, but the present invention is not limited to these.

### EXAMPLES

### Example 1

Results of comparison of a variety of properties between copolymer polyester resins that form molded articles for dental use according to the present invention and resins that have conventionally been utilized (polycarbonate resins and polyether sulfone resins)

The resins that were utilized in the experiments are as follows:
Product 1 according to the present invention: Eastar 6763 made by Eastman Chemical Company (molecular ratio of PET/PCT>1.0)
Product 2 according to the present invention: Eastar DN004 made by Eastman Chemical Company (molecular ratio of PET/PCT<1.0)
Product 1 according to the prior art: a polycarbonate resin (a commercially available product having a grade suitable for injection molding)
Product 2 according to the prior art: a polyether sulfone resin (a commercially available product having a grade suitable for injection molding)
   1) Detection Test of an Environmental Hormone Substance (Endocrine Disrupting Substance)

Testing method: a molded article made of any of the above described resins was submerged in pure water of which the amount is 200 ml for every 5.6 g of the molded article for a week at 60° C. The gained solution was analyzed according to high performance liquid chromatography (detection limit: 0.0005 μg/ml (0.5 ppb)), and the existence of a detected environmental hormone substance was confirmed.

Testing results: The state of detection of each type of molded article that has been determined in accordance with the above described method is as follows:

| | |
|---|---|
| Product 1 according to the present invention: | Not detected |
| Product 2 according to the present invention: | Not detected |
| Product 1 according to the prior art: | Detected |
| Product 2 according to the prior art: | Not detected |

2) Comparison Test of Color Tones and Esthetics

Testing method: Color tones and esthetics at the time of wearing within an oral cavity of each type of molded article that was formed using the materials that had been colored in advance so as to have a color tone of a molded article for dental use were evaluated with the eye.

Testing results: color tones and esthetics of each type of molded article that was evaluated according to the above described method are as follows:

| | |
|---|---|
| Product 1 according to the present | Good |
| invention: | |
| Product 2 according to the present | Good |
| invention: | |
| Product 1 according to the prior | Good |
| art: | |
| Product 2 according to the prior | Problem(thematerialitself |
| art: | is translucent yellow, and |
| | therefore, it was difficult |
| | to adjust the color of the |
| | molded article for dental use) |

3) Test of Adhesion Strength

Testing method: first, a masking tape with an opening having a diameter of 5 mm was pasted to each type of molded article that had been adjusted to the dimensions of 15 mm×15 mm×3 mm so as to define the area of adhesion. Next, an acryl rod having a diameter of 5 mm was planted using Miky Plus (made by Nissin Dental Products Inc.), which is a quick cure dental resin. After the tested body was left for not less than 3 hours, a tensile test was conducted at a test speed of 2 mm/min, using Autograph AG-50B (made by Shimadzu Corporation), and in this manner, the strength of adhesion is evaluated. Testing results: the strength of adhesion of each type of molded article that was measured in accordance of the above described testing method are as follows:

| | |
|---|---|
| Product 1 according to the present invention: | 271 kgf/cm² |
| Product 2 according to the present invention: | 164 kgf/cm² |
| Product 1 according to the prior art: | 141 kgf/cm² |
| Product 2 according to the prior art: | 33 kgf/cm² |

4) Test of Resistance to Solvent MMA

Testing method: each type of molded article that was adjusted to the dimensions of 15 mm×15 mm×3 mm was put in reflux of boiling water for one hour, and after that, methyl methacrylate (hereinafter abbreviated as MMA) was dripped onto the molded article after it had been sufficiently dried. Then, the solubility on the surface and the existence of cracking were confirmed by the eye in the case where MMA was immediately wiped off and in the case where MMA was wiped off after one minute.

Testing results: resistance to solvent of each type of molded article that was measured in accordance with the above described testing method is as follows:

| | Immediately after | Contact for one |
|---|---|---|
| | contact | minute |
| Product 1 according to the | ◯ | ◯ |
| present invention: | | |
| Product 2 according to the | ◯ | ◯ |
| present invention: | | |
| Product 1 according to the | ◯ | X |
| prior art: | | |
| Product 2 according to the | ⊚ | X (cracking and |
| prior art: | | destruction) |

Determination reference/⊚: no coarseness on the surface and no cracking,
◯: almost no coarseness on the surface and no cracking, and
X: coarseness on the surface and cracking

Determination reference/\textcircled{∘}: no coarseness on the surface and no cracking, ◯: almost no coarseness on the surface and no cracking, and ×: coarseness on the surface and cracking
5) Test of Resistance to Wear (Rate of Wear when Scrubbed with a Toothbrush)

Testing method: each type of molded article that was adjusted to a dimensions of 5 mm×5 mm×7 mm was made to absorb water for 24 hours at 37° C. After that, the molded article was made to slide on a toothbrush (having four brush heads, by Butler #411) that had been soaked in a polishing liquid (a suspension of 700 g of toothpaste (Dentor T Lion (made by Lion Corporation))+350 ml of pure water) 10000 times (2000 m) and 20000 times (4000 m) at 150 gf, and the rate of wear was calculated from the reduction in weight after scrubbing.

Testing results: the rate of wear when scrubbed by a toothbrush of each type of molded article that was measured (wt. %) in accordance with the above described testing method are as follows:

| | 10000 times | 20000 times |
|---|---|---|
| Product 1 according to the present | 4.2% | 8.5% |
| invention: | | |
| Product 2 according to the present | 6.2% | 12.5% |
| invention: | | |
| Product 1 according to the prior art: | 2.5% | 4.5% |
| Product 2 according to the prior art: | 3.2% | 6.1% |

6) Total Evaluation and Determination

The molded articles of Products 1 and 2 according to the present invention are excellent in safety, adhesiveness, resistance to impact shock and resistance to wear, and are appropriate for use as a molded article for dental use.

In contrast, the molded article of Product 1 according to the prior art is excellent in physical properties, but has a problem of elution of bisphenol A, and is not very appropriate for use as a molded article for dental use. In addition, the molded article of Product 2 according to the prior art has problems with color tone, adhesiveness and strength when contacted with MMA, and therefore, is inappropriate for a molded article for dental use.

### INDUSTRIAL APPLICABILITY

A molded article for dental use according to the present invention is formed of an amorphous plastic copolymer polyester resin made up of PET constitutional units and PCT constitutional units, and therefore, has no problem where there is a fear of elution or production of bisphenol A at the time of use, unlike polycarbonate that has conventionally been used, and is excellent in safety. In addition, this copolymer polyester resin has excellent physical properties and good mold ability, and therefore, has the advantage of being easy to process into a mold in a variety of forms, such as temporary crowns, denture bases and artificial teeth, using a general purpose molding machine.

In addition, a molded article for dental use according to the present invention that has been formed to a form such as a temporary crown exhibits excellent adhesiveness to an MMA-PMMA resin with sufficient resistance (resistance to wear, resistance to shock impact and the like) in the case of actual use in a patient.

1. A molded article for dental use having a predetermined form so as to be suitable for use in an oral cavity, characterized in that the molded article is formed of a copolymer polyester resin made up of polyethylene terephthalate constitutional units and poly-1,4-dimethylene cyclohexane terephthalate constitutional units.

2. The molded article for dental use according to claim 1, characterized in that said molded article for dental use has a form selected from the group consisting of a temporary crown, a denture base, an artificial tooth and an orthodontic device.
